(19) United States
(12) Patent Application Publication
(10) Pub. No.: US 2007/0043971 A1
(43) Pub. Date: Feb. 22, 2007

(54) Error identifying apparatus

(76) Inventor: Takashi Suzuki, Tokyo (JP)

Correspondence Address: CANTOR COLBURN, LLP, 55 GRIFFIN ROAD SOUTH, BLOOMFIELD, CT, 06002, US

(21) Appl. No.: 11/298,210

(22) Filed: Dec. 8, 2005

(30) Foreign Application Priority Data
Aug. 18, 2005 (JP) JP2005-237853

(51) Int. Cl. G06F 11/00

(52) U.S. Cl. 714/11

(57) ABSTRACT

An apparatus, including a plurality of units, each has at least one function which is executed by a software; an error detecting section which detects an error of the apparatus; a selector section which selects at least one of arbitrary unit of the units, when the error is detected by the error detecting section; an obtaining section which obtains from an external device a software function identical to a function of a selected unit by the selector; and an execution section which executes an operation of the apparatus based on the function obtained by the obtaining section.

### RELATED APPLICATION

This application is based on Japanese Patent Application No. 2005-237853 filed with Japan Patent Office on Aug. 18, 2005, the entire content of which is hereby incorporated by reference.

### BACKGROUND

1. Field of the Invention

The present invention refers to a technique for identifying an error in case the error occurs in an apparatus structured with multiple units.

2. Description of the Related Art

When a trouble occurs on an apparatus structured with a combination of multiple components and units such as electronic circuit boards, machine units, electronic devices, integrated circuits and sensors, it is a general practice to detect the erroneous portion by a pre-installed self-diagnostic program or determine the type of error from the error code outputted upon the trouble occurrence.

In the meantime, in case of developing an application program, it frequently happens that a hardware unit necessary for the operational test of the application program has not been completed yet or that preparation of all hardware units necessary for the test is not easy. Accordingly, it becomes a general practice to run an operational test of the application program on an emulator. that virtually realizes the operation of hardware units by means of software.

There has been a technique where, for example, various virtual units each of which functions as emulator are registered in a distribution server on the internet so as to enable a system developer to down-load a necessary virtual unit for his development environment from the distribution server and run a connection test without using hardware units necessary for the system (see the Patent Document 1, for example).

[Patent Document 1] Japanese Application Patent Laid-Open Publication No. 2003-233513

The technique for virtually realizing the operation of a hardware unit by means of software is a technique for substituting it for a specific hardware unit that cannot be readily prepared in reality at the time of developing a program or system, and is not intended to be used for determining an erroneous portion. Accordingly, the above self-diagnostic program or the like has been mostly employed for determining an erroneous portion.

However, because a self-diagnostic program detects the erroneous portion based on a negative phenomenon including, for example, no response from a specified unit or no reaction from a specified sensor, there is no guarantee that the apparatus resumes normal operation after the erroneous portion has been replaced or repaired. Consequently, there has been a case where the apparatus does not resume normal operation even after replacing the unit that has been determined to be erroneous. Particularly in a case where the erroneous portion is determined through remote diagnosis and a serviceman brings a new unit into the site for replacement purpose, it would be a waste of time and money if the apparatus cannot be repaired in the end. In addition, if the erroneous portion determined by a self-diagnostic program is wrong, it has been extremely difficult to identify the real erroneous portion. Furthermore, once an error occurs, even a temporary operation of the apparatus is not available until the erroneous portion has been repaired.

### SUMMARY

Aiming to resolve the above problems, an object of the present invention is to offer an apparatus, error diagnosis system, and error identification procedure that can identify an erroneous portion exactly. Another object is to enable an apparatus to be put into temporary operation without repairing the failure actually.

In view of foregoing, an object of this invention is to solve at least one of the problems, and to provide new apparatus. The apparatus comprises a plurality of units, each has at least one function which is executed by a software; an error detecting section which detects an error of the apparatus; a selector section which selects at least one of arbitrary unit of the units, when the error is detected by the error detecting section; an obtaining section which obtains from an external device a software function identical to a function of a selected unit by the selector; and an execution section which moves the apparatus based on the software function obtained by the obtaining section.

According to another aspect of the present invention, the apparatus comprises a plurality of units, each has at least one function which is executed by a software; an error detecting section which detects an error of the apparatus;

an error notifying section which notifies an occurrence of the error to an external device, when the error detecting section detects the error of the apparatus; a receiving section which receives from the external device a designation information designating at least one of arbitrary unit of the units; an obtaining section which obtains a software function identical to a function of a designated unit designated by the designation information; an execution section which executes the apparatus based on the software function obtained by the obtaining section; and a result notifying section which notifies a result of an execution by the execution section to the external device.

According to another aspect of the present invention, the apparatus comprises a plurality of units, each has at least one function which is executed by a software; an emulating section which provides a software function identical to a function of the units; an error detecting section which detects an error of the apparatus; a selector section which selects at least one of arbitrary unit of the units, when the error is detected by the error detecting section; an obtaining section which obtains from the emulating section a software function identical to a function of a selected unit by the selector; an execution section which executes the apparatus based on the software function obtained by the obtaining section; and a judgment section which specifies a portion of a cause of the error in accordance with a result of an execution by the execution section, wherein the selector section selects another unit of the units, when the judgment section does not specify the portion of the cause of the error.

The invention itself, together with further objects and attendant advantages, will best be understood by reference to the following detailed description taken in conjunction with the accompanying drawings.

### BRIEF DESCRIPTION OF THE DRAWINGS

FIG. 1 is an explanatory figure showing a brief construction of the error diagnosis system to which the embodiment of present invention applies together with the functions of the apparatus in a tree structure;

FIG. 2 is a block diagram showing the functional configuration of the error diagnosis system to which the present invention applies;

FIG. 3 is a state chart of the diagnostic operation by the error diagnosis system to which the present invention applies;

FIG. 4 shows an explanatory example of the operation sequence of the diagnostic operation, in which an operator is involved, by the error diagnosis system to which the present. invention applies;

FIG. 5 shows an explanatory example of the operation sequence of the diagnostic operation, in which no operator is involved, by the error diagnosis system to which the present invention applies;

FIG. 6 is an explanatory figure showing a brief construction of a multi-functional machine referred as an example apparatus in the error diagnosis system to which the present invention applies;

FIG. 7 is an explanatory figure showing part of an example tree structure representing the functions of a multi-functional machine;

FIG. 8 is an explanatory figure showing an emulation sequence in the separation level 2 in the diagnostic operation for a multi-functional machine;

FIG. 9 is a flow chart showing the processes executed by an image processing board upon facsimile transmission of an image read out by an image reading section of a multi-functional machine;

FIG. 10 is a flow chart showing the processes executed by an image compression/extension unit upon facsimile transmission of an image read out-by an image reading section of a multi-functional machine;

FIG. 11 is a block diagram showing a construction of an error diagnosis system in which the emulation sequence and erroneous portion are determined by the apparatus side;

FIG. 12 is a block diagram showing a construction of an error diagnosis system that can complete the diagnostic operation by itself.

In the following description, like parts are designated by like reference numbers throughout the several drawings.

### DETAILED DESCRIPTION OF THE PREFERRED EMBODIMENT

Preferred embodiment of the invention is described hereunder, using drawing figures.

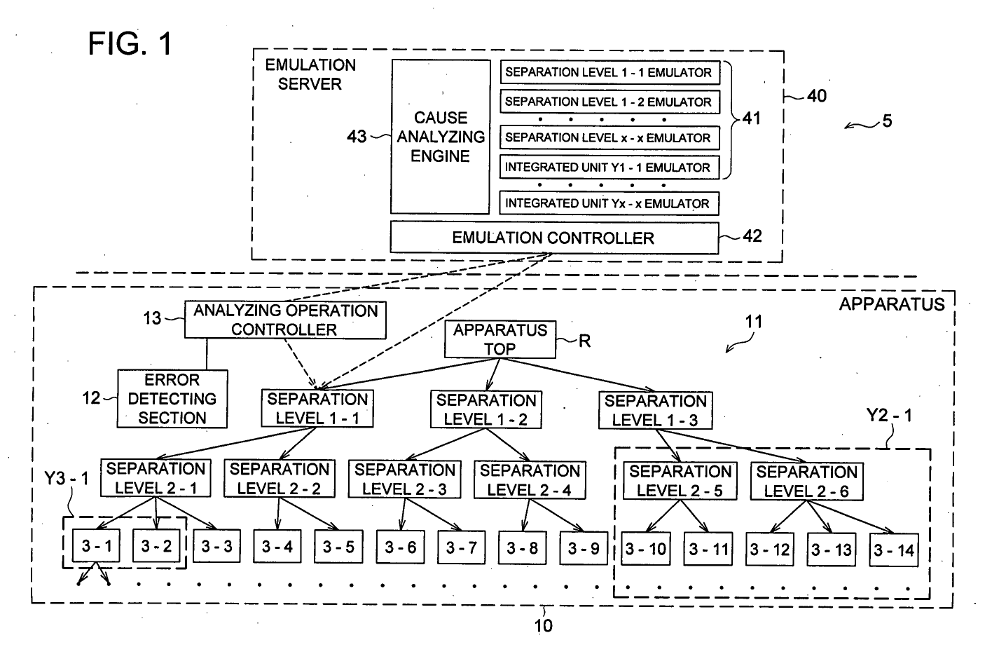

FIG. 1 shows a brief construction of the error diagnosis system 5 to which the present invention applies. The error diagnosis system 5 comprises an apparatus 10 to be diagnosed and an emulation server 40 as external terminal. The apparatus 10 and emulation server 40 are connected with each other by a communication means such as internet or LAN (local area network).

The apparatus 10 comprises multiple units 11, each of which is a mass of one or more functions that can be substituted by software (hereinafter, sometimes called emulation), error detecting section 12, and analyzing operation controller 13.

The unit 11 is an assembly of one each or multiple electronic components, electronic boards, and integrated circuit chips (for example ASIC (application specific integrated circuit)) installed on an electronic board. That is, the unit 10 can be regarded to have a hierarchical structure, consisting of multiple major units according to brief classification, multiple electronic boards contained in the major units, and integrated circuits included in each electronic board; and each layer can be regarded as a unit. From a functional view, a mass of one or more functions can be regarded as a unit irrespective of their physical boundary. For example, a unit can consist of a mass of multiple integrated circuits located on different electronic boards.

In this description, the apparatus 10 is not only regarded as a mass of functional units but also controlled in a tree structure where the functions of the apparatus 10 are classified hierarchically. In FIG. 1, the root R of the tree structure represents the whole apparatus 10 and the apparatus 10 is briefly divided into three units 1-1, 1-2 and 1-3 in the first layer under it. In the second layer under the first layer, each unit 1-1, 1-2 and 1-3 belonging to the first layer is subdivided into multiple minor units 2-1 through 2-6. As shown herein, a unit in each layer is further divided into multiple units in the layer under it.

In the error diagnosis system 5, nodes in each layer under the tree structure can be regarded as a unit and a unit in a higher layer fulfills the function of a mass of all units belonging to lower layers under it. In addition, some units out of multiple units belonging to lower layers of a unit can be integrated and handled as a single unit (integrated unit). Integrated unit is shown in a broke-line frame in FIG. 1. For example, the figure shows an integrated unit Y3-1 that integrates unit 3-1 and unit 3-2 of the third layer, and an integrated unit Y2-1 that unties unit 2-5 and unit 2-6 of the second layer.

The error diagnosis system 5 is a system that diagnoses which unit in the tree structure is the point of cause of error in case the apparatus 10 fails. The system separates the function of a desired unit from the apparatus 10, operates the unit functionally by emulating it by a software function provided by the emulation server 40, and determines the point of cause of error from the result of the operation. The analyzing operation controller 13 supervises and controls the apparatus 10 for the above diagnostic operation. Each layer of the tree structure in FIG. 1 corresponds to the separation level of unit in the software emulation; for example, the first layer is at the separation level 1 and the second layer is at the separation level 2.

The emulation server 40 comprises an emulator 41 that fulfils the same function as a unit in the apparatus 10, emulation controller 42 that controls the interface with the apparatus 10 and the operation of the emulator 41, and a cause analyzing engine 43 that determines the search route for analyzing the cause of error. Emulator 41 is provided for every unit in each layer of the tree structure and for every definable integrated unit.

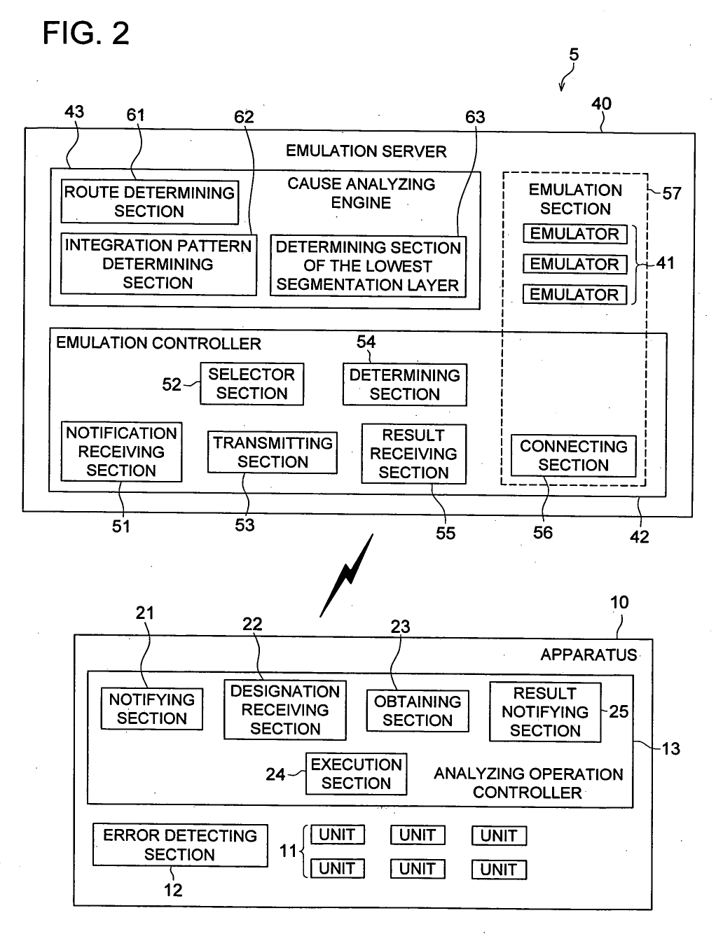

FIG. 2 shows more precisely the functional configuration of the apparatus 10 and emulation server 40. The analyzing operation controller 13 of the apparatus 10 functions as a notifying section 21, designation receiving section 22, obtaining section 23, execution section 24, and result notifying section 25. The emulation controller 42 of the emulation server 40 functions as a notification receiving section 51, selector section 52, transmitting section 53, determining section 54, result receiving section 55, and connecting section 56.

The notifying section 21 of the apparatus. 10 functions to notify the emulation server 40 of the occurrence of error detected by an error detecting section 12. The notification receiving section 51 of the emulation server 40 functions to receive the above notification from the apparatus 10. The selector section 52 functions to select at least one optional unit out of the multiple units contained in the apparatus 10. The transmitting section 53 functions to transmit the designation information, indicating the unit selected by the selector-section 52, to the apparatus 10.

The designation receiving section 22 of the apparatus 10 functions to receive the designation information from the emulation server 40. The obtaining section 23 functions to obtain a software function, which fulfils the same function as the unit designated by the designation information received by the designation receiving section 22, from the emulation server 40. To be concrete, it functions to connect an emulator 41 corresponding to the function of the unit designated by the designation information with the execution section 24 of the apparatus 10 via a telecommunication line and the connecting section 56 of the emulation server 40. The emulation controller 42 forms instance of the corresponding emulator 41 and operates it according to the request from the apparatus 10. The controller along with the emulator 41 and connecting section 56 additionally function as an emulation section 57 for providing a software function to the apparatus 10.

The execution section 24 functions to operate the apparatus 10 by emulating the function of the unit, designated by the above designation information, by the software function obtained from the emulation server 40. To speak more precisely, the section functions to switch the connection so that signal and information for the unit to be emulated by the software function can be inputted and outputted to/from the corresponding emulator 41 of the emulation server 40. That is to say, the section separates the unit designated by the designation information from the apparatus 10 and transmits the information, which has been inputted to this separated unit from other units, to the emulation server 40 via a telecommunication line. The connecting section 56 of the emulation server 40 inputs the received information to the corresponding emulator 41 and also transmits the output information of the emulator 41 to the apparatus 10. The execution section 24 of the apparatus 10 treats the information received from the emulation sever 40 as the information outputted from the above separated unit, and so operates that the information is inputted to a unit to which the original output from the separated unit is to be inputted.

For example, in case information is exchanged by radio between units, the information can be transmitted and/or received to/from the corresponding emulator 41 in the emulation server 40 via the execution section 24 if the destination of a unit, for which the separated unit has been identified as destination, is switched to the execution section 24 in the analyzing operation controller 13. In case units are connected with cables, a switching unit is applicable to switch the connection.

The result notifying section 25 functions to transmit the operation result of the execution section 24 to the emulation server 40.

The result receiving section 55 of the emulation server 40 functions to receive the operation result from the apparatus 10; and the determining section 54 functions to identify the point of cause of error based on the operation result received by the result receiving section 55 from the apparatus 10. If the apparatus 10 resumes normal operation as a result of the emulation by the software function (emulator 41), the unit can be determined to be the point of cause of the error.

If the determining section 54 cannot identify the point of cause of error from the above operation result, the selector section 52 functions to select another unit. In other words, until the point of cause of error can be identified, the section repeats selecting another unit to be emulated by the emulator 41, operating the apparatus 10 by emulating the function of the unit by the emulator 41, and obtaining the operation result for its determination. Identifying the point of cause of error terminates only when a cause unit can be identified in a desired layer (separation level) in the tree structure in FIG. 1 and, even if a cause unit is found in a higher layer, the system regards that the point of cause of error has not yet been identified.

The cause analyzing engine 43 comprises a route determining section 61, integration pattern determining section 62, and lowest segmentation layer determining section 63. The route determining section 61 functions to determine the search route of the point of cause of error. For example, if an error code indicating the type of error is received from the notification section 21 of the apparatus 10 as the notification of error, the section determines which unit and which layer to start the emulation according to the error code.

The integration pattern determining section 62 functions to determine how to integrate multiple segmented units into a unit. The lowest segmentation layer determining section 63 functions to determine in which layer the point of cause of error can be regarded to have been identified (called as the lowest segmentation layer). Use of the cause analyzing engine 43 facilitates to pin-point the cause of error efficiently.

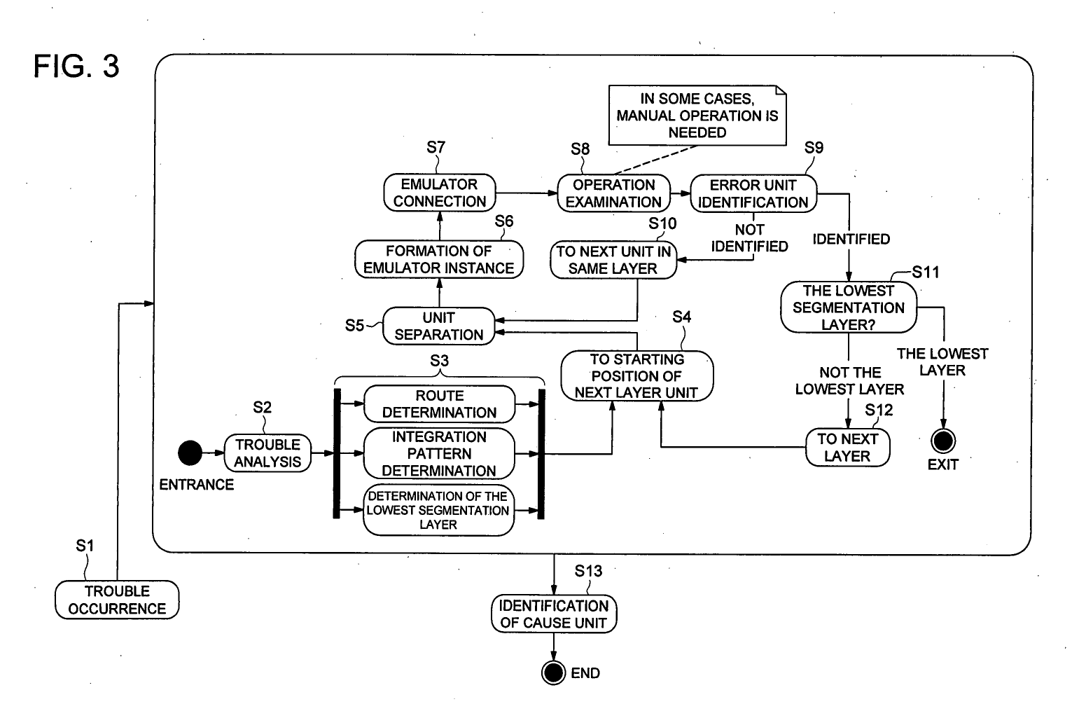

FIG. 3 is a state chart of the diagnostic operation by the error diagnosis system 5 in case the functions of units can be represented by a tree structure shown in FIG. 1. If a trouble occurs in the apparatus 10 (S1), diagnostic operation starts. To begin with, the cause analyzing engine 43 analyzes the trouble (S2), which is then followed by route determination for searching the cause unit of error, integration pattern determination, and determination of the lowest segmentation layer by the cause analyzing engine 43 according to the type of the trouble (S3).

Next, any one of the units located in the highest layer in the route determined by the cause analyzing engine 43 is set as the starting position of the units to be emulated by the software function (emulator 41) (S4). This unit is separated from the apparatus 10 (S5), instance of the emulator 41 for fulfilling the same function as the unit is formed (S6), and the emulator is connected to the apparatus 10 in place of the above separated unit (S7). Then, the apparatus 10 is operated by emulating the function of the separated unit by the emulator 41 to examine the operation (S8). This operation examination may start either automatically after the emulator connection or manually such as by an operator's action. If the examination can be started only after the operator has set some medium, it is regarded as manual start.

Next, the cause unit of error is identified based on the result of the examination of operation (S9). For example, if the apparatus 10 operates normally, the unit being emulated by the emulator 41 at present is determined to be the cause unit of the error. If cause unit cannot be identified in the present layer, another one in the same layer is selected as the unit to be emulated next (S10), and the above sequences from S5 to S9 are repeated.

If the cause unit of error can be identified in the present layer, whether the present layer is the lowest segmentation layer specified by the cause analyzing engine 43 or not is determined (S11), and the operation moves to the next lower layer if it is not the lowest segmentation layer (S12). Then, any one of the units belonging to the lower layer is set as the unit to be emulated (S4), and a series of the sequences from S5 are executed. When the cause unit of error can be identified in the lowest segmentation layer specified by the cause analyzing engine 43, the diagnostic operation terminates (S13).

If, for example, the above operation starts from the unit 1-1 in the first layer (separation level l) of FIG. 1, any one of the units is identified as the cause unit in the course of emulation in order of unit 1-1, unit 1-2, and unit 1-3, and the operation moves to the second layer (separation level 2). Then, any one of the units is identified as the cause unit in the course of emulation in order of unit 2-1, unit 2-2, . . . and unit 2-6, and the operation moves to the third layer (separation level 3). A similar operation is repeated until the cause unit can be identified in the lowest segmentation layer.

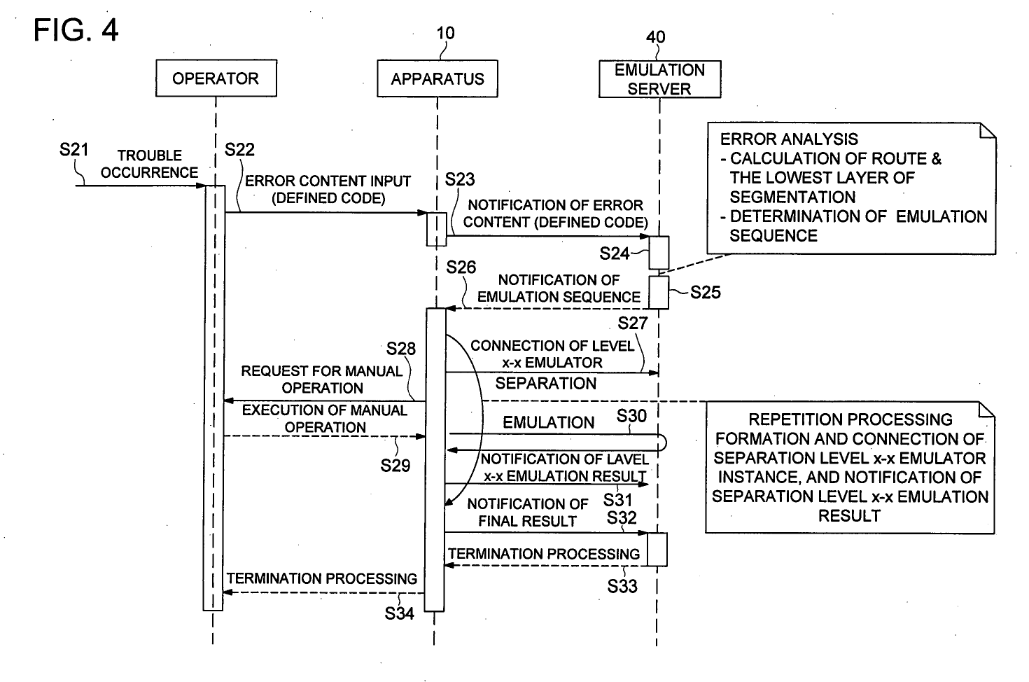

FIG. 4 shows an example of the operation sequence from the occurrence of trouble up to the identification of a cause unit, in which an operator is involved. The operator judges an occurrence of trouble (S21) from the operating condition and output result of the apparatus 10, and inputs an error code corresponding to the type of error from an operation panel (not shown) (S22).

The apparatus 10 notifies the error code inputted by the operator to the emulation server 40 (S23). The emulation server 40 analyzes the trouble in the cause analyzing engine 43 (S24), and calculates, using a specified computation algorithm, the route for searching the cause unit of the error, integration pattern, and lowest segmentation layer and determines the emulation sequence (S25).

The emulation server 40 selects the unit to be emulated next based on the determined emulation sequence, and transmits the designation information indicating the unit to the apparatus 10 (S26). The apparatus 10 separates the unit designated by the designation information and also connects to the emulator 41 that fulfills the same function as the separated unit (S27).

When the connection to the corresponding emulator 41 is complete, the apparatus 10 requests a specified operation to the operator (S28) and, upon the execution of the operation by the operator (S29), starts the operation examination using the emulator 41 (S30). And then, the apparatus 10 notifies the emulation server 40 of the result of the examination (S31). In case the examination result is checked by the operator, the operator may be requested to select “Resumed” or “Not resumed”, for example, and this selected answer can be notified to the emulation server as the examination result. The above sequences from S26 to S31 are repeated, while changing the unit to be emulated, until the cause unit is identified in the lowest segmentation layer.

When the cause unit is identified in the lowest segmentation layer, termination of the operation. is confirmed between the apparatus 10 and emulation server 40 (S32, S33), and the apparatus 10 notifies the operator of the cause unit of error and termination of the diagnostic operation (S34). Here, a series of sequences are complete.

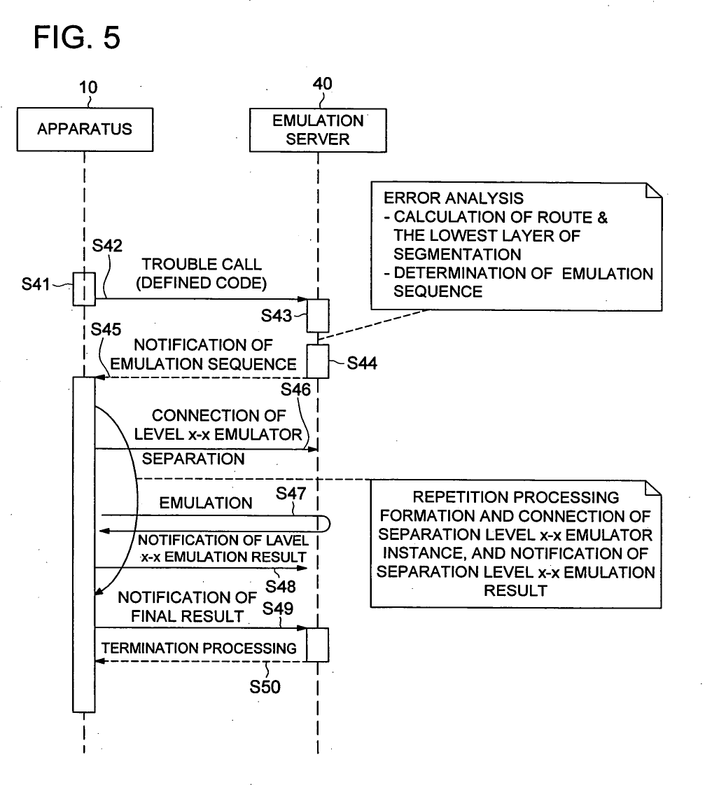

FIG. 5 shows an example of the operation sequence from the occurrence of error up to the identification of a cause unit, in which no operator is involved. The apparatus 10 recognizes an occurrence of error (S41), and notifies the emulation server 40 of an error code corresponding to the type of error (S42). The emulation server 40 analyzes the error in the cause analyzing engine 43 (S43), and calculates the route for searching the cause unit of the error, integration pattern, and lowest segmentation layer and determines the emulation sequence (S44).

The emulation server 40 selects the unit to be emulated next based on the determined emulation sequence, and transmits the designation information indicating the unit to the apparatus 10 (S45). The apparatus 10 separates the unit designated by the designation information received from the emulation server 40 and also connects to the emulator 41 corresponding to the unit (S46).

When the connection to the emulator 41 is complete, the apparatus 10 automatically starts the operation examination using the emulator 41 (S47) and notifies the emulation server 40 of the result of the examination (S48). The above sequences from S45 to S48 are repeated, while changing the unit to be emulated, until the cause unit is identified in the lowest segmentation layer. When the cause unit is identified in the lowest segmentation layer, termination of the operation is confirmed between the apparatus 10 and emulation server 40 (S49, S50), and a series of sequences are complete.

Because the cause unit of error is identified through repeated examination operation of the apparatus 10 by emulating the function of a unit by the emulator 41, while changing the unit to be emulated, the point of cause of the error can be identified without fail and normal operation of the apparatus 10 is ensured by replacing or repairing the identified unit.

If the corresponding emulator 41 is allowed to continue emulating the function of the unit that has been identified as the cause unit of the error, the unit can be put into service without replacement or repair, that is, temporary operation in case of emergency becomes available.

Next, the operation of the error diagnosis system 5, in a case where the apparatus 10 to be diagnosed is an image forming apparatus, is described hereunder.

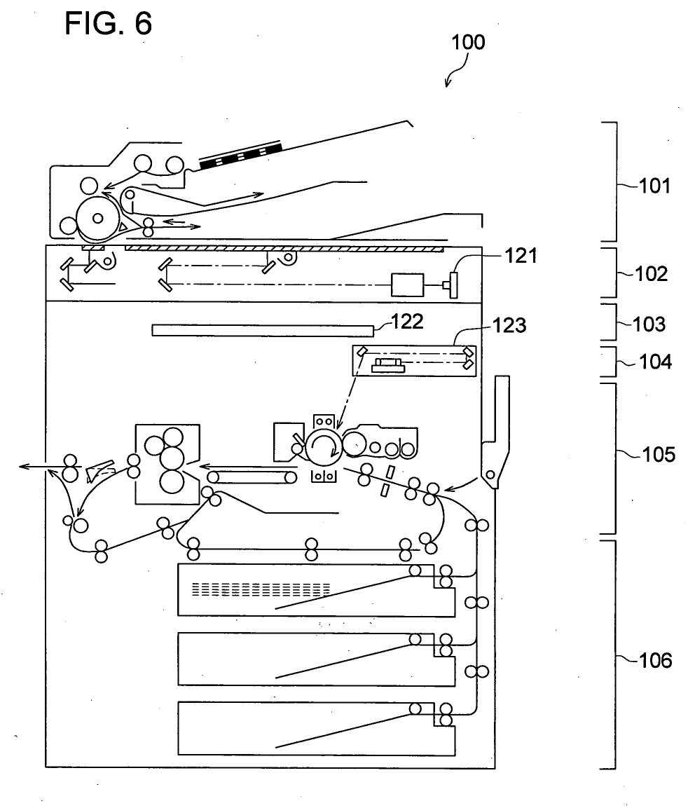

FIG. 6 shows schematically a construction of a multi-functional machine 100 as image forming apparatus. The multi-functional machine 100 has a copying function for reading an original and printing out a copy image on a recording paper, a facsimile function for transmitting a read-out image to a destination terminal via a telecommunication line or receiving an image sent from the destination, and a printing function for printing articles according to the print data sent from a personal computer or the like.

The multi-functional machine 100 comprises an automatic original feeder 101 that conveys one original after another from an original tray to a reading position, image reading section 102 that reads the image of the original, image processing section 103 that adds various processes to the image data obtained by reading an original, image forming section 105 that forms an image on a recording paper through an electro-photographic process, image exposing section 104 that forms a latent image on a photo-sensitive drum in the image forming section 105 according to the image data, and paper feeder 106 that feed the recording paper.

In this embodiment, it is assumed that trouble occurred is the distortion on the output image upon facsimile transmission due to a failure of later-mentioned compression/extension chip. It is also assumed that the cause of the trouble is a failure of the extension function on an image processing board and that the conversion of image width (millimeter/inch) has failed at the time when the image data obtained by the image reading section 102 is forwarded to the facsimile transmission process.

The trouble occurrence is recognized by an operator and the operator inputs an error code corresponding to the trouble from an operation panel of the multi-functional machine 100. The input is then transmitted from the multi-functional machine 100 to the emulation server 40 and the emulation sequence is determined by the cause analyzing engine 43 installed in the emulation server 40. The cause analyzing engine 43 roughly finds out “digital image processing system” to be an erroneous portion based on the error code received from the multi-functional machine 100. The “digital image processing system” is briefly divided into (1) CCD unit 121, (2) image processing board 122, and (3) exposing system unit 123. The CCD unit 121 functions to convert analog image signal to digital signal. The image processing board 122 is a circuit unit that provides various image processes to the image data digitalized by the CCD unit 121. The write system unit 123 functions to modulate on/off the laser diode of the image exposing section 104 based on the image data processed by the image processing board 122.

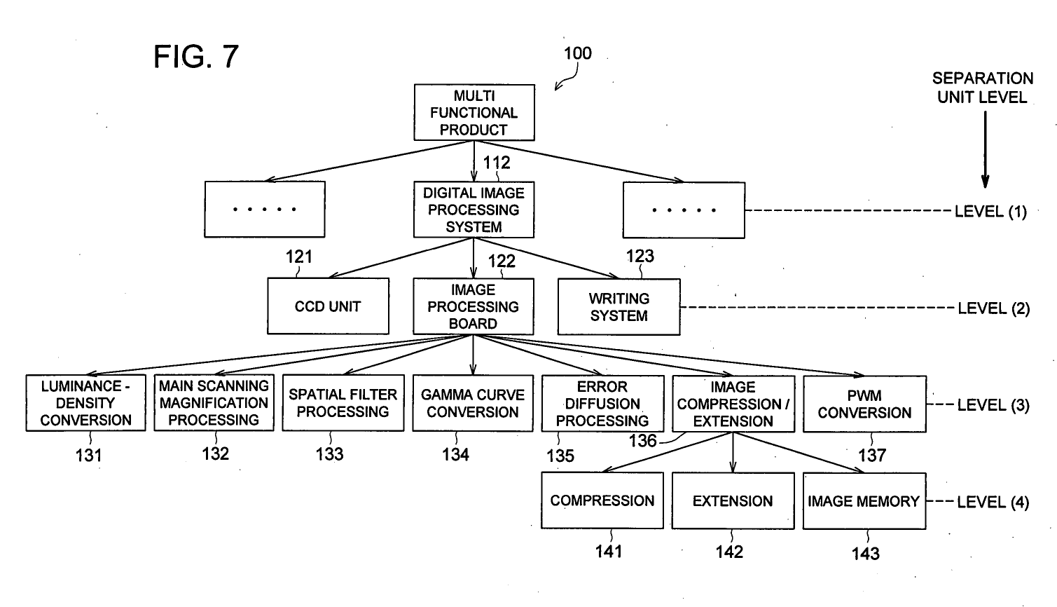

FIG. 7 shows a tree structure of the functions of the multi-functional machine 100, concentrated to the portions related to the trouble in this example (occurrence of distortion on the output image upon facsimile transmission due to a failure of compression/extension chip). The first layer (separation level 1) is a layer of briefly divided units of the multi-functional machine 100 and the digital image processing system unit 112 is included herein. The digital image processing system unit 112 is subdivided into the above CCD unit 121, image processing board 122, and write system unit 123. These units belong to the second layer (separation level 2).

The image processing board 122 is further subdivided into a luminance-density conversion unit 131, main scanning magnification processing unit 132, spatial filter processing unit 133, gamma curve conversion unit 134, error diffusion processing unit 135, image compression/expansion unit 136, and PWM conversion section 137. These units belong to the third layer (separation level 3). The image compression/expansion unit 136 is further subdivided into a compression unit 141, extension unit 142, and image memory 143, all of which belong to the fourth layer (separation level 4).

Since the cause analyzing engine 43 has roughly found out the digital image processing system 112 to be an erroneous portion based on the error code received from the multi-functional machine 100, the starting position of the emulation is set at the second layer (separation level 2) to which the lower three units 121, 122 and 123 of the digital image processing system 112 belong. In addition, the lowest segmentation layer is set at the fourth layer (separation level 4) to which the compression unit 141 and others belong.

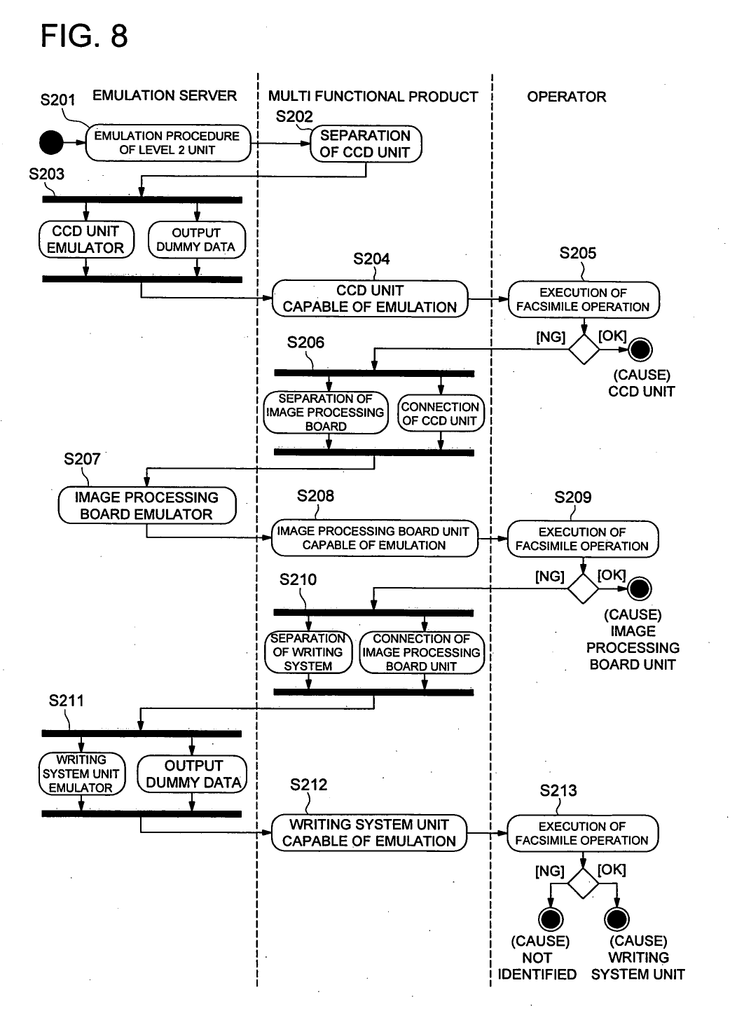

FIG. 8 shows the flow of the diagnostic operation in the separation level 2 of which emulation sequence has been set as above. The emulation server 40 notifies the multi-functional machine 100 of the above emulation sequence (S201). To be concrete, it notifies of the separation of the CCD unit 121 in the form of designation information. The multi-functional machine 100 separates the designated CCD unit 121 (S202) and the emulation server 40 sets ready an emulator for CCD unit and dummy data for output (S203). It must be noted in this embodiment that, since the whole functions of the CCD unit 121 and write system 123 cannot be emulated by software, dummy data for output made available in the emulation server 40 is to be employed.

When the emulation of the CCD unit 121 becomes available, the apparatus 10 requests the operator to operate the machine for facsimile transmission. When the operator executes the operation (S205), the facsimile transmission operation is executed by emulating the function of the CCD unit 121 by the corresponding emulator on the emulation server 40 side. The operator judges whether the result of this operation is normal or not and inputs the result from the operation panel. If the operation result is normal, the system identifies the CCD unit 121 as the cause unit in the separation level 2 and moves to the diagnostic operation in the next separation level 3.

If it is not identified as the cause unit, the separation of unit and connection of emulator are performed next for the image processing board 122 (S206, S207), and when the emulation of the image processing board 122 becomes available (S208), the facsimile transmission operation is requested to the operator again. When the operator executes the operation (S209), the facsimile transmission operation is executed by emulating the function of the image processing board 122 by the corresponding emulator on the emulation server 40 side, and the system waits for an input of the operation result from the operator. If it is normal, the system identifies the image processing board 122 as the cause unit in the separation level 2 and moves to the diagnostic operation in the next separation level 3.

If it is not identified as the cause unit, the separation of unit and connection of emulator are performed next for the exposing system unit 123 (S210, S211), and when the emulation of the exposing system unit 123 becomes available (S212), the facsimile transmission operation is requested to the operator again. When the operator executes the operation (S213), the facsimile transmission operation is executed by emulating the function of the exposing system unit 123 by the corresponding emulator on the emulation server 40 side, and the system waits for an input of the operation result from the operator. If it is normal, the system identifies the exposing system unit 123 as the cause unit in the separation level 2 and moves to the diagnostic operation in the next separation level 3. If the machine does not resume normal operation even after the above, the diagnostic operation is terminated, leaving the cause not identified.

In this example, the image distortion in facsimile transmission is eliminated only through the emulated operation of the image processing board 122 and so the image processing board 122 is identified as the cause unit in the separation level 2. Consequently, the diagnostic operation in the next separation level is performed for the units belonging to the next lower layer (separation level 3) of the image processing board 122.

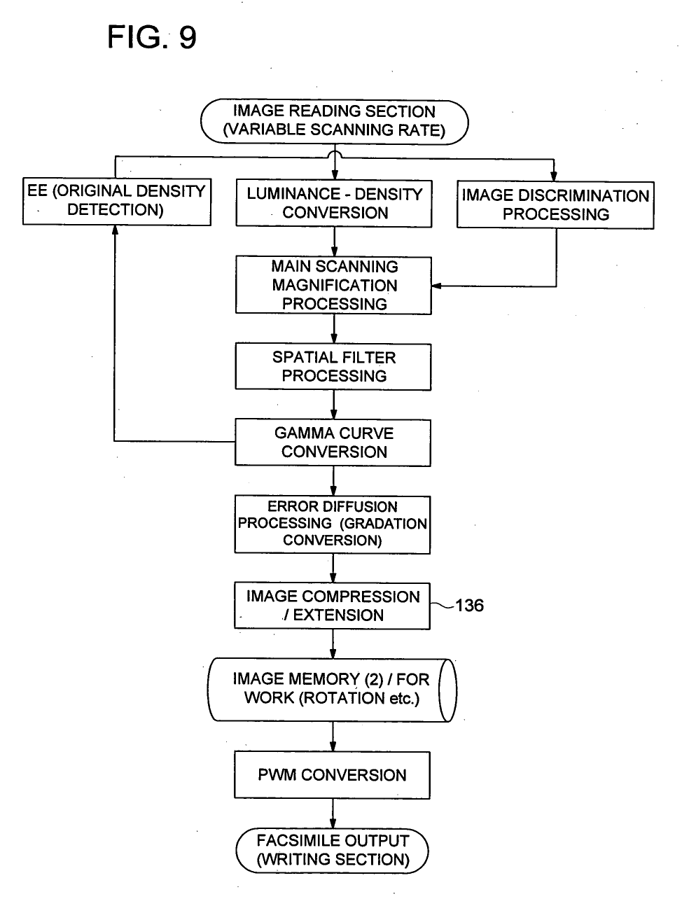

FIG. 9 shows the flow of processes for facsimile transmission of the image read out by the image reading section 102. Each functional section (each section in square frame) in the figure is the function that belongs to the lower layer of the image processing board 122, and they are defined as the unit to be emulated in the separation level 3. Since the sequence for separating and emulating the unit is similar to those in the separation level 2 shown in FIG. 8, further explanation is not given.

In this example, the image distortion in facsimile transmission is eliminated only through the emulated operation of the image compression/expansion unit 136 and so the image compression/expansion unit 136 is identified as the cause unit in the separation level 3. Consequently, the diagnostic operation in the next separation level is performed for the units belonging to the next lower layer (separation level 4) of the image compression/expansion unit 136.

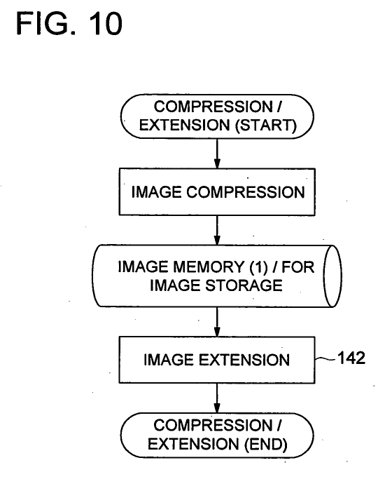

FIG. 10 shows the flow of processes for facsimile transmission of the image read out by the image compression/expansion unit 136. Each functional section (each section in square frame) in the figure is defined as the unit to be emulated in the separation level 4. Since the sequence for separating and emulating the unit is similar to those in the separation level 2 shown in FIG. 8, further explanation is not given.

In this example, the image distortion in facsimile transmission is eliminated only through the emulated operation of the extension unit 142 and so the image extension unit 142 is identified as the cause unit in the separation level 4. Because the separation level 4 is defines as the lowest segmentation level of this diagnostic operation, the diagnostic operation is terminated here and the extension unit 142 is identified as the cause of the trouble.

In the error diagnosis system 5 explained above is constructed to have a cause analyzing engine 43, selector section 52 and determining section 54 on the emulation server 40 side, but the construction and arrangement of each unit/section of the error diagnosis system 5 are not limited to the one shown in FIG. 1 and FIG. 2. It is permissible that the functions including the cause analyzing engine 43 and selector section 52 are provided on the apparatus 10 and that the emulation server 40 serves simply to provide an emulator specified by the apparatus 10. It is also permissible to include all functions of the emulation server 40 in the apparatus 10.

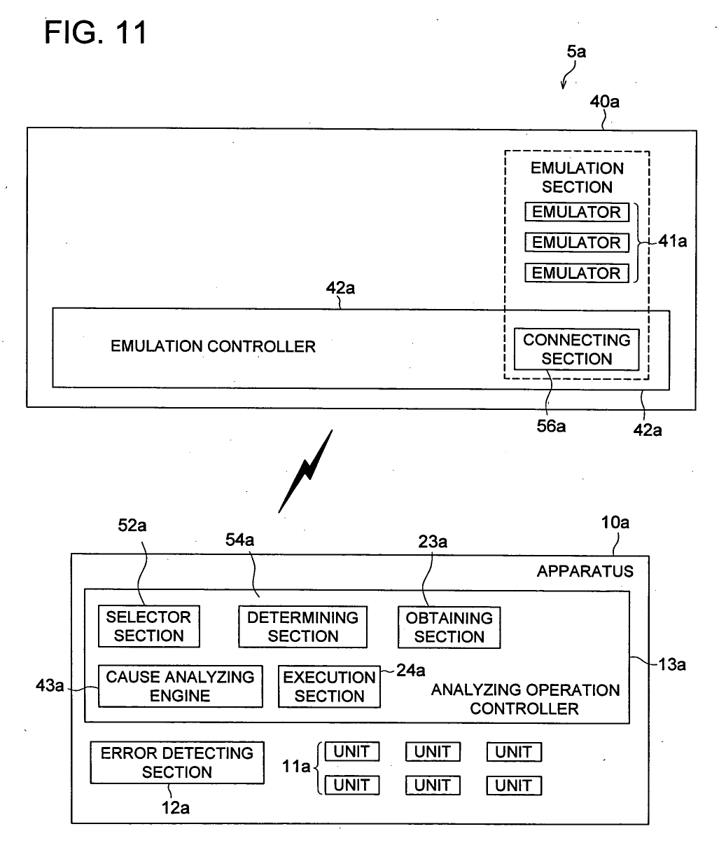

FIG. 11 shows an example of an error diagnosis system 5a where the emulation sequence and erroneous portion are determined by the apparatus side. A portion having the same function as in the error diagnosis system 5 in FIG. 2 is given the same symbol with a suffix “a”. In the error diagnosis system 5a in FIG. 11, when the error detecting section 12a detects an error of the apparatus 10a, the emulation sequence is determined by the cause analyzing engine 43a provided in the analyzing operation controller 13a of the apparatus 10a itself and furthermore the unit to be emulated is determined by the selector section 52a.

The obtaining section 23a obtains a software function, which fulfils the same function as the unit selected by the selector section 52a, from the emulation server 40a, and the execution section 24a operates the apparatus 10a by emulating the function of the above unit by the software function obtained from the emulation server 40a. The determining section 54a of the apparatus 10a determines the cause unit of the error based on the result of the emulated operation. Unit to be emulated is selected one after another according to the above emulation sequence and the diagnostic operation is repeated until the cause unit can be identified in the lowest segmentation layer.

In this error diagnosis system 5a, the emulation server 40a is simply required to actuate the emulator 41 requested by the obtaining section 23a of the apparatus 10a and connect to the apparatus 10a.

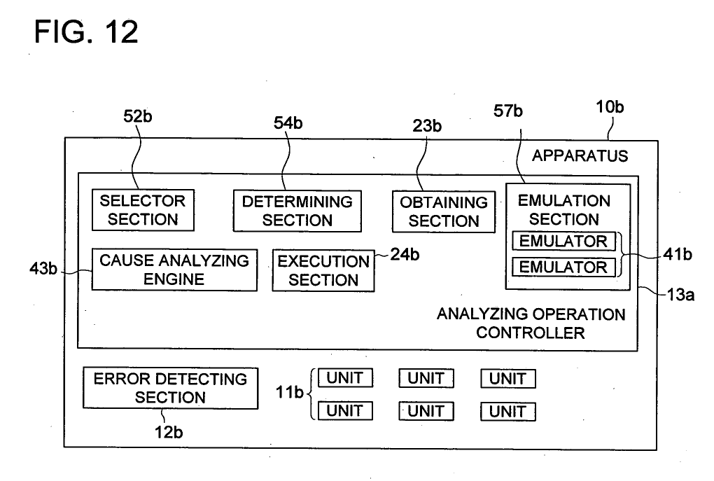

FIG. 12 shows a construction of the apparatus 10b that can complete the diagnostic operation by itself. A portion having the same function as in the error diagnosis system 5 in FIG. 2 is given the same symbol with a suffix “b”. The apparatus 10b is equipped with an emulation section 57b that offers a software function (emulator 41b) which fulfils the same function as each unit.

When the error detecting section 12b detects an error of the apparatus 10b, the emulation sequence is determined by the cause analyzing engine 43b provided in the analyzing operation controller 13b-of the apparatus 10b itself and furthermore the unit to be emulated is determined by the selector section 52b. The execution section 24b obtains a software function (emulator 41b), which fulfils the same function as the unit in question, from the emulation section 57b, and operates the apparatus 10b by emulating the function of the unit in question by the software function.

The determining section 54b of the apparatus lob determines the cause unit of the error based on the result of the emulated operation. Unit to be emulated is selected one after another according to the emulation sequence and the diagnostic operation is repeated until the cause unit can be identified in the lowest segmentation layer.

A preferred embodiment of the present invention has been described above but concrete construction of the invention is not limited to the one shown as the embodiment. Any modification and/or addition to it are included in the present invention so far as the intent of the invention is not lost.

For example, the functions of the apparatus 10 have been represented in a tree structure having a hierarchical structure in describing the embodiment but it can be a network structure or functions may be classified in another structure. Furthermore, unit is not limited to a single node in the tree structure or network structure but a mass of two or more nodes may be defined as a single unit.

The operation of the apparatus 10 under a condition where a unit is emulated by software is started automatically or manually by operator from the apparatus 10 side in this embodiment, but the operation of the apparatus 10 may be started automatically from the emulation server 40 side or started by a remote operation (manual) by the operator on the emulation server 40 side. The communication between the apparatus 10 and emulation server 40 can be either radio communication or wire communication.

The computation algorithm for determining the search route of the cause of error and lowest segmentation layer is not limited to the one shown in this embodiment. An algorithm for tracing from the top to the bottom in a tree structure enables to identify the cause of error efficiently but it is also permissible to employ an algorithm for searching each unit on a round-robin basis or to operate various units on a try-and-error basis by emulating the function of a unit by a software function so as to find out the cause of error.

In the emulation operation, it is also permissible to emulate the functions of independent multiple units by a software. function. For example, it is permissible to operate the apparatus while emulating both unit 2-1 and unit 2-5 of FIG. 1 at the same time.

Although the emulator on the emulation server 40 side is connected to the apparatus 10 in this embodiment, it is permissible to so construct the system that software for the emulator is down-loaded from the emulation server 40 to the apparatus 10 and the software is executed on the apparatus 10 for the emulation of the function of a unit.

The apparatus to which the present invention applies is not limited to the multi-functional machine 100 but may be any apparatus of which components are multiple units that can be emulated by software.

According to the embodiment of the present invention, when an error is detected, an optional unit is selected and the operation of the apparatus is executed by replacing the function of the selected unit with a software function obtained from an external terminal. If the apparatus resumes normal operation through emulation by the software function, the unit that has been replaced with the software function can be identified as the cause of the error. If the cause of the error cannot be identified, the unit to be emulated by a software function is changed to another so that the above operation is repeated. If the apparatus resumes normal operation through the emulation by the software function, the apparatus can be put into temporary operation under the emulation condition. “Can be emulated by a software function” means that the input and output to/from the unit can be realized virtually by means of software, wherein the internal construction of the unit does not matter and it can be a black box from a view point of software function. Each unit may be an electronic circuit, electronic device, or even a unit containing mechanical components so far as the input and output to/from the unit can be emulated by a software function. Unit shall not necessarily be physically single; a mass of physically multiple units can be regarded as a single unit or a physically single unit can be regarded as a logically (functionally) multiple units.

According to the embodiment of the present invention, when the apparatus notifies an external terminal of the occurrence of an error, the designation information of the unit to be emulated by a software function is sent from the external terminal. The apparatus obtains a software function, corresponding to the unit designated by the designation information, from the external terminal. Then, the apparatus is operated by replacing the function of the designated unit with the obtained software function and the result of the operation is transmitted to the external terminal. That is, the apparatus is only required to have a function for executing the operation while emulating the function of the unit designated by an external apparatus by the software function and for transmitting the result of the operation to the external apparatus. Determination of erroneous portion from the operation result and selection of the next unit to be emulated by a software function are processed by the external terminal.

According to the embodiment of the present invention, when the apparatus detects the occurrence of an error, it selects the unit to be emulated by a software function and obtains the software function corresponding to the unit from an external terminal. Then, the apparatus executes its operation while emulating the function of the unit selected by the apparatus by the software function obtained from the external terminal, and determines the cause of the error from the result of the operation. If the cause is not identified, it selects another unit and repeats the above operation. That is to say, the apparatus itself is equipped with the function for determining the cause of the error and for selecting the unit to be emulated by the software function. The external terminal simply provides the apparatus with the software function for the unit requested by the apparatus.

According to the embodiment of the present invention, when the apparatus detects occurrence of an error, it selects the unit to be replaced by a software function, obtains the software function, that fulfills the same function as the unit, from an emulation section of the apparatus itself, and executes its operation while emulating the function by the software function. Then, it determines the cause of the error from the result of the operation. If the cause is not identified, it selects another unit and repeats the above operation. That is to say, this apparatus can identify an erroneous portion independently without communicating with an external terminal.

In an error diagnosis system, error identification procedure and apparatus to which the present invention applies, the cause of the error can be identified as an apparatus is operated by emulating the function of a unit by a software function and the unit to be emulated is changed one after another. In addition, by emulating the function of an erroneous unit by a software function, the apparatus can be put into temporary operation without physical repair of the error, which is particularly useful in case parts replacement and immediate repair are not available.

It is to be noted that various changes and modifications will be apparent to those skilled in the art. Therefore, unless such changes and modifications depart from the scope of the present invention, they should be construed as being included therein.

What is claimed is:

1. An apparatus, comprising:
a plurality of units, each has at least one function which is executed by a software;
an error detecting section which detects an error of the apparatus;
a selector section which selects at least one of arbitrary unit of the units, when the error is detected by the error detecting section;
an obtaining section which obtains from an external device a software function identical to a function of a selected unit by the selector; and
an execution section which executes an operation of the apparatus based on the software function obtained by the obtaining section.

2. The apparatus of claim 1, further comprising:
a judgment section which specifies a portion of a cause of the error in accordance with a result of an execution by the execution section,
wherein the selector section selects another unit of the units, when the judgment section does not specify the portion of the cause of the error.

3. The apparatus of claim 1, further comprising:
an error notifying section which notifies an occurrence of the error to the external device, when the error detecting section detects the error of the apparatus.

4. The apparatus of claim 1, wherein the execution section switches inputting and outputting information from the selected unit by the selector to the software function.

5. The apparatus of claim 1, wherein the execution section executes automatically or by an instruction from the apparatus itself or the external device.

6. The apparatus of claim 1, wherein the apparatus is an image forming apparatus and the external device is a server.

7. The apparatus of claim 1, wherein the unit is at least one of an electronic element, an electronic circuit, integration circuit on the electronic circuit and a combination thereof.

8. An apparatus, comprising:
a plurality of units, each has at least one function which is executed by a software;
an error detecting section which detects an error of the apparatus;
an error notifying section which notifies an occurrence of the error to an external device, when the error detecting section detects the error of the apparatus;
a receiving section which receives from the external device a designation information designating at least one of arbitrary unit of the units;
an obtaining section which obtains a software function identical to a function of a designated unit designated by the designation information;
an execution section which executes an operation of the apparatus based on the software function obtained by the obtaining section; and
a result notifying section which notifies a result of an execution by the execution section to the external device.

9. The apparatus of claim 8, wherein the execution section switches inputting and outputting information from the designated unit by the selector to the software function.

10. The apparatus of claim 8, wherein the execution section executes automatically or by an instruction from the apparatus itself or the external device.

11. The apparatus of claim 8, wherein the apparatus is an image forming apparatus and the external device is a server.

12. The apparatus of claim 8, wherein the unit is at least one of an electronic element, an electronic circuit, integration circuit on the electronic circuit and a combination thereof.

13. An apparatus, comprising:
a plurality of units, each has at least one function which is executed by a software;
an emulating section which provides a software function identical to a function of the units;
an error detecting section which detects an error of the apparatus;
a selector section which selects at least one of arbitrary unit of the units, when the error is detected by the error detecting section;
an obtaining section which obtains from the emulating section a software function identical to a function of a selected unit by the selector;
an execution section which executes an operation of the apparatus based on the software function obtained by the obtaining section; and
a judgment section which specifies a portion of a cause of the error in accordance with a result of an execution by the execution section,
wherein the selector section selects another unit of the units, when the judgment section does not specify the portion of the cause of the error.

14. The apparatus of claim 13, wherein the execution section switches inputting and outputting information from the selected unit by the selector to the software function.

15. The apparatus of claim 13, further comprising:
an error notifying section which notifies an occurrence of the error to an external device, when the error detecting section detects the error of the apparatus.

16. The apparatus of claim 13, wherein the unit is at least one of an electronic element, an electronic circuit, integration circuit on the electronic circuit and a combination thereof.
